(19) United States
(12) Patent Application Publication
(10) Pub. No.: US 2012/0117118 A1
(43) Pub. Date: May 10, 2012

(54) SEARCH AND DEEP LINKING IN INTERNET-ENABLED TV

(75) Inventors: Abhishek Patil, San Diego, CA (US); Dipendu Saha, San Diego, CA (US); Sriram Sampathkumaran, San Diego, CA (US)

(73) Assignee: SONY CORPORATION

(21) Appl. No.: 13/095,018

(22) Filed: Apr. 27, 2011

Related U.S. Application Data
(60) Provisional application No. 61/412,003, filed on Nov. 10, 2010.

(51) Int. Cl. G06F 17/30

(52) U.S. Cl. 707/792; 707/E17.005

(57) ABSTRACT

An Internet-enabled TV that provides virtual channels to online services that source content responds to a viewer search query by passing the query only to services designated as “searchable” and that thus possess a search application programming interface (API) to return links directly to the content and not just to the hosting services.

This application claims priority to U.S. provisional patent application Ser. No. 61/412,003, filed Nov. 10, 2010, incorporated herein by reference.

### I. FIELD OF THE INVENTION

The present application relates generally to content searching in Internet-enabled TVs.

### II. BACKGROUND OF THE INVENTION

Audio video (AV) devices such as TVs are growing increasingly capable, enabling viewers to watch videos from a wide range of sources with concomitant features. As understood herein, presenting additional information to viewers in an easy, intuitive, and non-cluttered way is desirable as more consumers demand increased access to supplemental information without wanting to operate computers to obtain the information. Furthermore, present principles understand the desirability of an Internet TV which responds to content search queries by providing direct links to the content and not just to online services that host the content and that in turn must be searched again by the user for the sought-after content.

### SUMMARY OP THE INVENTION

An audio video (AV) device includes a video display and a processor accessing instructions on a computer readable medium to execute the instructions to control the display to present a search user interface (UI) on the display. The processor accesses links to a set of services at least some of which are designated as being searchable services. The processor, responsive to a query input to the search UI, sends the query to the searchable services and only to the searchable services. In other words, the processor does not send the query to services that are not designated as searchable. The processor presents a query results list from the services on the display.

In some implementations the services include at least one non-searchable service, and the processor does not send the query to the non-searchable service. The query is, however, sent to the searchable services, in a predetermined query order if desired (e.g., business partnership or user preference or other ordering paradigm). Further, the results on the results list may be presented on the display if desired in a predetermined results order. The results order defines, for example, a first service and a second service, with results from the first service being presented higher on the results list than results from the second service in accordance with the results order.

In example embodiments the processor includes results on the results list that are received prior to expiration of a timeout period. The processor does not present any results on the results list that are received after expiration of the timeout period. The results list may be superimposed on the search UI while the search UT remains visible on the display.

As discussed at greater length below, in some implementations, responsive to a viewer selection of an entry on the results list, the processor links directly to content represented by the link and available on the respective service.

In another aspect, an Internet-enabled TV provides virtual channels to online services that source content. The TV responds to a viewer search query by passing the query only to services designated as “searchable” to return links directly to the content and not just to the hosting services.

In another aspect, a method includes receiving, at an audio video (AV) device, a list of services from a management server. The list of services includes searchable services and non-searchable services, and the method includes receiving into the AV device a viewer query. The query is sent to searchable services on the list of services and not to non-searchable services on the list of services. Also, the query is sent to the searchable services in a predetermined query order. Responses are received from the searchable services prior to expiration of a timeout period and after expiration of the timeout period, so that only the responses received prior to expiration of the timeout period are presented in a predetermined searchable service response order and the responses received after expiration of the timeout period are not presented.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of an example system in accordance with present principles;

FIG. 2 is flow chart of overall example logic;

FIG. 3 is a screen shot of a search user interface (UI) with a results list that can be overlaid on the UI shown in phantom;

FIG. 4 is a screen shot of a guide UI presenting a content summary responsive to a link being selected from the results list; and

FIGS. 5 and 6 are process flow diagrams illustrating details of an example specific embodiment.

### DETAILED DESCRIPTION OF THE PREFERRED EMBODIMENT

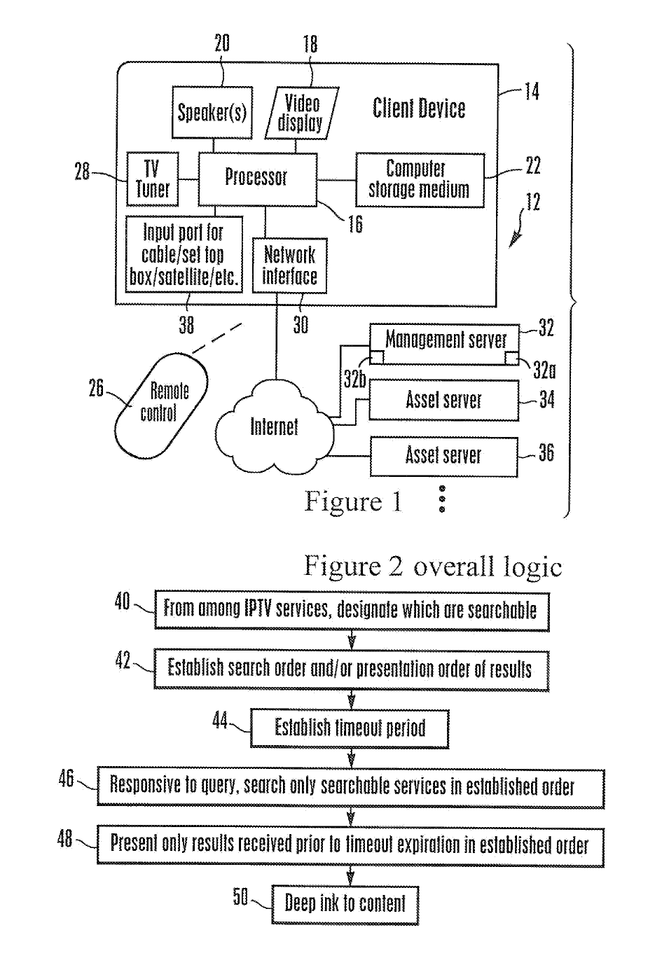

Referring initially to FIG. 1, an audio video (AV) display device 12 such as a TV includes a housing 14 bearing a digital processor 16. The AV device 12 alternatively may be a mobile telephone or personal digital assistant or digital clock radio or other device capable of presenting AV. The processor 16 can control a visual display 18 and an audible display 20 such as one or more speakers. The visual display may be a touch screen display or high definition TV display or other appropriate video display.

To undertake present principles, the processor 16 may access one or more computer readable storage media 22 such as but not limited to RAM-based storage (e.g., a chip implementing dynamic random access memory (DRAM)) and/or flash memory and/or disk-based storage. Software code implementing present logic executable by the AV device 12 may be stored on one of the memories to undertake present principles.

If desired, in addition to the touch screen the processor 16 can receive user input signals from various input devices, including a keypad, a remote control device 26, a point and click device such as a mouse, etc. A TV tuner 28 may be provided in some implementations particularly when the CE device is embodied by a TV to receive TV signals from a source such as a set-top box, satellite receiver, cable head end, terrestrial TV signal antenna, etc. Signals from the tuner 28 are sent to the processor 16 for presentation on the display 18 and speakers 20.

As shown in FIG. 1, a network interface 30 such as a wired or wireless modem or wireless telephony transceiver communicates with the processor 16 to provide connectivity to one or more Internet servers, including a management server 32 with respective processors 32a and respective computer readable storage media 32b. The management server 32 may provide the AV device 12 with selective access to AV content from one or more “searchable” asset servers 34 and one or more non-searchable asset servers 36. By “searchable” is meant an asset server which can receive queries from the AV device 12 according to below principles and return direct links to conforming content without requiring the AV device 12 to open a native search page of a service on the server, as opposed to asset servers 36 which support only searches launched from a native search page of the service hosted by the server. One or more AV input ports 38 can also be provided to receive television programming from respective sources including a disk player, a set top box, a cable head end, a satellite, a terrestrial broadcast antenna.

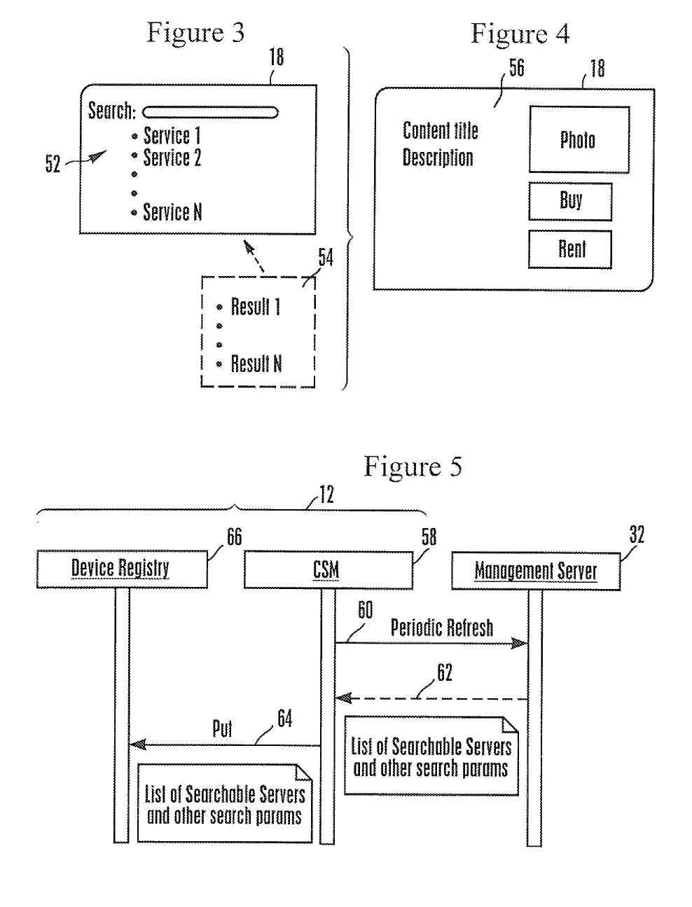

Now referring to FIG. 2, the manufacturer of the AV device 12 configures the AV device 12 to have “virtual channels”, i.e., content-providing websites of entities with whom the manufacturer has partnered according to various business arrangements. Each website provides a respective service and each website typically is hosted on one of the asset servers 34, 36 shown in FIG. 1. As set forth further below in reference to FIG. 3, the AV device 12 presents links which may be represented by icons to the various services on the display 18 for selection by a viewer of the service to present content from the service on the display 18.

At block 40, from among the services, those that are “searchable” in accordance with principles herein directly from the AV device 12 without having to employ the native search page of the service are designated “searchable”. It will be appreciated that a “searchable” service is affiliated with a searchable asset server 34. A “searchable” service typically agrees pursuant to a business arrangement with the manufacturer of the AV device 12 to accept and employ an application programming interface (API) which accepts queries from AV devices 12 and, without opening a native search page of the service, directly and transparently to the user searches for content of the service that satisfies the query and returns links thereto to the AV device 12.

Block 42 indicates that a query order in which queries are sent to the searchable services (asset servers 34) may be established according to business needs. For example, service A may be established to be the first service to which a query is sent, followed by service B, and so on. Also or alternatively a response order in which query responses are presented on the display 18 can be established by service, so that, for instance, responses from service A are presented first on the display 18, then responses from service B second, and so on.

A timeout period may also be established at block 44. The timeout period may be fixed at some default period and if desired the viewer of the AV device 12 may be permitted to change the period by means of a setup user interface (UI) presented on the display 18. Likewise, the user may be permitted to change the results order established at block 42.

Proceeding to block 46, responsive to a query input using, e.g., the example search UI of FIG. 3 discussed further below, the processor 16 sends the query only to those asset servers (hosting respective services) affiliated with virtual channels that have been designated as “searchable” at block 40. The queries are sent to the searchable services in the query order established at block 42.

Moving to block 48, results which are received prior to expiration of the timeout period established at block 44 are presented on the display 18 in the response order established at block 42, in the form of links to the underlying content. Results received after expiration of the timeout period are discarded and not displayed. The importance of the query order may now be appreciated, because those services that are earlier in the query order have more time to respond prior to timeout expiration than those that are later in the query order.

Block 50 indicates that responsive to a viewer selecting one of the links in the displayed results, the viewer is linked directly to a guide UI dedicated to the content associated with the link in accordance with further discussion below.

FIG. 3 illustrates an example search UI 52 that may be presented on the display 18. As shown, the search UI 52 lists multiple services that are available online and that can provide AV content to the AV device 12 when a service is selected. The search UI may also include a search input element as shown into which a viewer may type a query.

As discussed above the query is sent to the searchable services only, in some examples in a predetermined query order, and responses returned, if desired in a predetermined response order, and such responses are shown in the UI 54 of FIG. 3 (showing results 1-N). In an example implementation, the response UI 54 is overlaid onto the search UI 52 and the search UI grayed or lowlighted.

As also discussed above, a viewer can click on one of the responses, which links the viewer directly to the underlying content on the associated searchable asset server 34. In non-limiting examples, the asset server 34 executing the above-described API returns a guide UI 56 shown in FIG. 4 that pertains to the underlying content of the selected link. The example guide UI shown includes a photograph related to the content, the content title, a text description of the content, and “buy” and “rent” selector elements which may be selected by a viewer to buy or rent, respectively, the content in the event that the content is pay content. In other implementations no guide UI need be provided; rather, in response to selection of a link from the results UI 54 the processor 16 may immediately start streaming the associated content from the associated asset server 34, presenting the content on the display 18 and/or speakers 20.

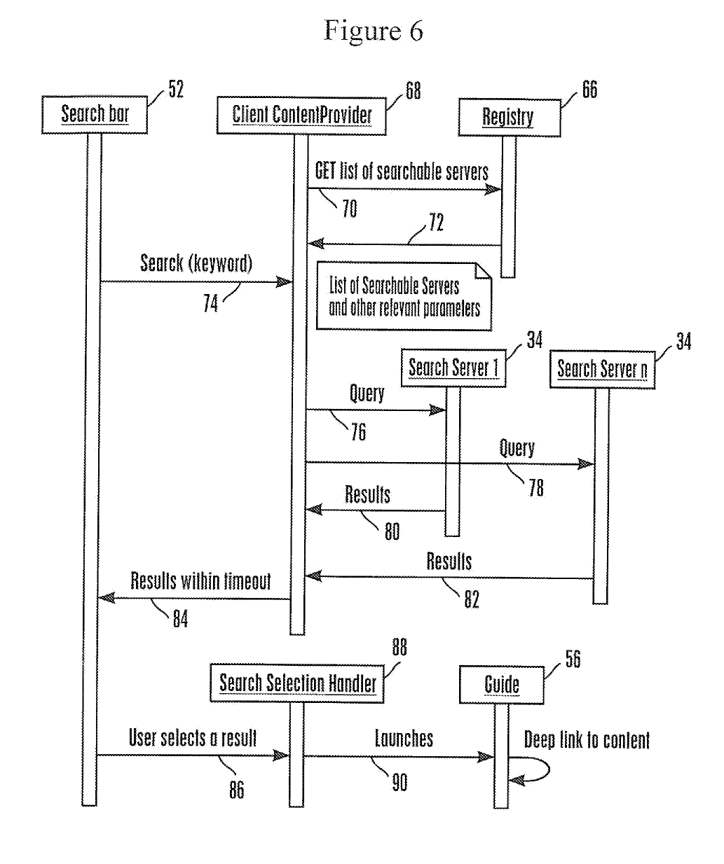

FIGS. 5 and 6 show implementation details of an example embodiment. A content service manager (CSM) module 58 (FIG. 5) that may be stored on the medium 22 and executed by the processor 16 sends, at 60, a periodic refresh request to the management server 32. At 62 a list of available services is returned, including designations of which ones are searchable in accordance with principles above. At 64 the CSM module 58 provides the list to a device registry 66 that also may be stored on the medium 22 and executed or accessed by the processor 16.

Moving to FIG. 6, a client content provider (CCP) module 68 that may be stored on the medium 22 and executed by the processor 16 sends a GET message to the registry 66 at 70 and obtains the list at 72. The registry 66 may return a list of all available services, searchable or not, and designate those that are searchable using, e.g., a flag, so that the searchable services subsequently may be identified and the non-searchable services not presented with the query. Or, the registry 66 may weed out the non-searchable services and return at 72 only the searchable services to the CCP module 68.

In any case, a search from the viewer inputting a query term to the search bar of the search UI 52 of FIG. 3 may be received at 74 by the CCP module 68. In response, the CCP module 68 sends, at 76, the query to a first searchable service server 34 and at 78 to a second searchable server 34, and so on in the query order established above, until all searchable services identified in FIG. 2 and only the searchable services have been sent the query. Results from the respective servers are returned at 80/82 and those results and only those results received prior to expiration of the timeout period are presented on the display 18 (e.g., in the form of the results UI 54 of FIG. 3) at 84. At 86, a viewer may clock on a link on the results UI 54 which is sent to a search selection handler (SSH) 88 module executed by the processor 16. The SSH module 88 launches, at 90, the guide UI shown in FIG. 4 or begins streaming the content itself by deep-linking to the associated content in the associated asset server 34 as described above.

While the particular SEARCH AND DEEP LINKING IN INTERNET-ENABLED TV is herein shown and described in detail, it is to be understood that the subject matter which is encompassed by the present invention is limited only by the claims.

What is claimed is:

1. Audio video (AV) device comprising:
video display;
processor accessing instructions on a computer readable medium to execute the instructions to control the display to present a search user interface (UI) on the display, the processor accessing links to a set of services at least some of which are designated as being searchable services;
the processor, responsive to a query input to the search UI, sending the query to the searchable services and only to the searchable services, the processor not sending the query to services not designated as searchable, the processor presenting a query results list from the services on the display.

2. The AV device of claim 1, wherein the services include at least one non-searchable service, the processor not sending the query to the non-searchable service.

3. The AV device of claim 1, wherein the query is sent to the searchable services in a predetermined query order.

4. The AV device of claim 1, wherein the results on the results list are presented on the display in a predetermined results order, the results order defining at least a first service and a second service, results from the first service being presented higher on the results list than results from the second service in accordance with the results order.

5. The AV device of claim 1, wherein the processor includes results on the results list that are received prior to expiration of a timeout period, the processor not presenting any results on the results list that are received after expiration of the timeout period.

6. The AV device of claim 1, wherein the results list is superimposed on the search UI while the search UI remains visible at least in part on the display.

7. The AV device of claim 1, wherein responsive to a viewer selection of an entry on the results list, the processor links directly to content represented by the link and available on the respective service.

8. An Internet-enabled TV providing virtual channels to online services that source content, the TV responding to a viewer search query by passing the query only to services designated as “searchable” to return links directly to the content and not just to the hosting services.

9. The TV of claim 8, wherein the TV includes a processor and a display, the processor, responsive to a query input to a search UI presented on the display, sending the query to searchable services and only to the searchable services, the processor not sending the query to services not designated as searchable, the processor presenting a query results list from the searchable services on the display.

10. The TV of claim 9, wherein the services include at least one non-searchable service, the processor not sending the query to the non-searchable service.

11. The TV of claim 9, wherein the query is sent to the searchable services in a predetermined query order.

12. The TV of claim 9, wherein the results on the results list are presented on the display in a predetermined results order, the results order defining at least a first service and a second service, results from the first service being presented higher on the results list than results from the second service in accordance with the results order.

13. The TV of claim 9, wherein the processor includes results on the results list that are received prior to expiration of a timeout period, the processor not presenting any results on the results list that are received after expiration of the timeout period.

14. The TV of claim 9, wherein the results list is superimposed on the search UI while the search UI remains visible at least in part on the display.

15. The TV of claim 9, wherein responsive to a viewer selection of an entry on the results list, the processor links directly to content represented by the link and available on the respective service.

16. Method comprising:
receiving, at an audio video (AV) device, a list of services from a management server, the list of services including at least one searchable service and at least one non-searchable service;
receiving into the AV device a viewer query;
sending the query to searchable services on the list of services and not to non-searchable services on the list of services, the query being sent to the searchable services in a predetermined query order;
receiving responses from the searchable services prior to expiration of a timeout period and after expiration of the timeout period; and
presenting on the display the responses received prior to expiration of the timeout period in a predetermined searchable service response order and not presenting on the display the responses received after expiration of the timeout period.

17. The method of claim 16, comprising discarding the responses received after expiration of the timeout period.

18. The method of claim 16, wherein the results are superimposed on a search UI while the search UI remains visible at least in part on the display.

19. The method of claim 16, wherein responsive to a viewer selection of a result, the method comprises linking directly to content represented by the result and available on the respective service.
